(19) United States
(12) Patent Application Publication
(10) Pub. No.: US 2015/0165845 A1
(43) Pub. Date: Jun. 18, 2015

(54) Valve Stem for a Pneumatic Wheel

(71) Applicant: Aeromind, LLC, Indianapolis, IN (US)

(72) Inventor: Joshua Poertner, Indianapolis, IN (US)

(73) Assignee: Aeromind, LLC, Indianapolis, IN (US)

(21) Appl. No.: 14/574,116

(22) Filed: Dec. 17, 2014

Related U.S. Application Data
(60) Provisional application No. 61/917,227, filed on Dec. 17, 2013.

(51) Int. Cl. B60C 29/00

(52) U.S. Cl. CPC B60C 29/005

(57) ABSTRACT

A valve stem extender can be coupled to a valve stem having a fluid receiving passageway for use with a vehicle wheel and tire. The valve stem extender includes a body having a proximal end portion, a distal end portion, an interior passageway extending between the distal and proximal end portions, and an exterior. The proximal end portion includes a coupler for coupling the valve stem extender to a valve stem to place the interior passageway of the valve stem in fluid communication with the fluid receiving passageway of the valve stem extender. The distal end portion is configured for receiving an air introducing device. The body includes a compressible portion. The compressible portion is radially compressible between a relatively larger diameter relaxed position, and a relatively smaller diameter compressed position for snugly coupling the valve stem extender to a vehicle wheel.

### PRIORITY CLAIM

The instant application claims benefit of priority to Joshua Poertner U.S. Provisional Patent Application No. 61/917,227 that was filed on 17 Dec. 2013, and which is fully incorporated herein by reference.

### I. TECHNICAL FIELD OF THE INVENTION

The present invention relates to pneumatic rims and tires and more particularly to valve stems and valve stem extenders for use with pneumatic wheels.

### III. BACKGROUND OF THE INVENTION

Prior to the 1990s, most bicycle rims had a relatively shallow cross section. A typical bicycle rim would comprise an extruded piece of aluminum or steel that was bent into a hoop, the ends of which were joined together to form an endless rim. Such rims include a radially outwardly facing tire-engaging surface, and a radially inwardly facing surface. A plurality of spokes extend radially inwardly from the rim to be joined to a centrally located hub. The hub includes an axle to enable the wheel to rotate about the axle.

The radially outwardly facing surface of such rims typically have a concave cross sectional area for receiving a tire assembly. Normally, a tire assembly is comprised of two part assembly that includes an relatively thin walled inflatable tube that was surrounded by a separate, relatively thicker and more durable, but still elastic tire casing member. The inner tube included a radially inwardly extending valve stem that had a proximal or base portion coupled to the tube, and a distal and radially inwardly disposed air pump receiving end.

Because of the relatively shallow cross section of most conventional wheels, valve stems were typically designed to be reasonably short, having a typical length of between 37 mm., and 42 mm. This length was more than adequate for use on conventional extruded metal wheels having a shallow cross section, as the distance on such wheels between the radially inwardly facing surface and the radially outwardly facing surface of such wheels was typically in a range of about 0.1 mm to 10 mm or so, thus providing a 37 mm valve stem with plenty of length to extend radially inward of the radially inwardly facing surface of the rim to enable the valve stem to be gripped appropriately by an air pump connector.

The early 1990s saw the advent and increased use of rims having much deeper cross sectional areas. The depths of such rims substantially exceeds the depth described above for traditional extruded aluminum hoop-type rims.

For example, one of the most popular rims sold by Zipp® Speed Weaponry® brand rims is the 404 model rim that has a 58 mm depth. The 202 model rim has a depth of 32 mm, and the largest and deepest non-disc rim currently sold by Zipp® is the 808 model, that has an 82 mm depth. Additional examples of deep cross sectioned rims are shown at Ording and Poertner, U.S. Pat. Nos. 6,991,298 and 7,114,785.

Another related development is that tubeless tires have been increasingly used with bicycle wheels, where formerly tubeless wheels were almost used exclusively. Currently, the valve stems used with such tubeless tires are separate from the tires, but no greater in length than the valve stems used for conventional tubes.

In order to accommodate these deeper sectioned rims, the current practice is to affix an extension on to the existing valve stem. These valve extensions include a proximal end that is coupled to the distal end of the distal end of the existing valve stem. The extensions also include an air pump receiving distal end for receiving the coupler of an air pump.

Currently, two types of extensions are used commonly. The first type of extension comprises an extension that replaces the valve core in those valve stems having removable valve cores. These removable valve core stems are commonly referred to as “RVC” type stems.

These RVC type stem extenders include a proximal end having male threads that threadedly engage the female threads of the original valve stem. RVC extensions also include female threads at the distal end that are sized and configured to accept a valve core.

A second type of commonly used valve extension used comprises a valve stem having a proximal end with female threads that threadedly engage the male threads on the distal end of a valve core that is inserted into the distal end of the valve stem. These types of valve stem extenders simply act as a chamber that is capable of holding pressure between the pump head and the valve core during inflation. These valve stem extenders can actuate a valve core actuator that is disposed as the distal end of the valve stem through the exertion of air pressure on the valve core, as Presta valves do not require a mechanical mover to actuate them to open them, but rather, can be actuated to open as a result of an over-pressure situation.

Valve stem extenders are available from a wide variety of suppliers, including Zipp (www.zipp.com), Topeak, and others.

Although the above-referenced extensions do enable one to connect an air pump to a tube or tire chamber in order to inflate the tire, the above-referenced valve stems extensions suffer certain drawbacks. In particular, the design of current valve stem extensions often cause them to rattle when in use, and especially when the vehicle is being ridden over rough surfaces. This rattling is due to the combination of the center of mass of the extension, and the relatively loose fit of the extension in the corresponding stem holder in the rim.

In order to enable a valve stem extension to be inserted into a rim, the valve stem extension is typically sized so that it has an outer diameter that is less than the inner diameter of the aperture through which it is intended to extend. In a typical case, the difference in diameter between the valve stem extension and the aperture through which it is received is about 2 mm to 3 mm.

One particularly annoying drawback that this dimensional difference causes is that the gap formed between the valve stem extension and the aperture through which it extends will often allow water and moisture to enter the interior cavity of the deep sectioned rim. For example, instances have been recorded in professional racing wherein as much as 0.5 liters of water have entered the aperture between the valve stem and the rim so that the water takes up residence within the interior of the rim. Although the half liter of water that found its way inside the rim is somewhat extreme as it occurred during a six hour race in heavy rain, smaller quantities of water often find their way inside the rim.

This seemingly small quantity (0.5 liters) can have a significant impact on the vehicle's performance.

A simple metric conversion determines that 500 mm of water equals 500 grams (1.1 lbs.) of water. Placed in perspective, the 500 grams of weight added by the water is not significantly less than the weight (740 g) of a Zipp® 404 Firecrest® carbon clincher wheel). This additional weight burden can be highly detrimental to the cyclist enjoyment of his ride, and can add a substantial amount of the working force required to propel the bike forward.

In view of these disabilities, one object of the present invention is to provide a valve stem or valve stem extender that is designed to accommodate deep section rims without the rattling and water intrusion characteristics inherent in known prior art valve stems and valve stem extenders.

### III. SUMMARY OF THE INVENTION

In accordance with the present invention, a valve stem extender is configured for being coupled to a valve stem having a fluid receiving passageway for use with a vehicle wheel and tire. The valve stem extender comprises a body having a proximal end portion, a distal end portion, an interior passageway extending between the distal and proximal end portions and an exterior. The proximal end portion includes a coupler for coupling the valve stem extender to a valve stem to place the interior passageway of the valve stem in fluid communication with the fluid receiving passageway of the valve stem extender. The distal end portion is configured for receiving an air introducing device. The body includes a compressible portion. The compressible portion is radially compressible between a relatively larger diameter relaxed position, and a relatively smaller diameter compressed position.

In a preferred embodiment, the valve stem extender includes a rigid portion disposed interiorly of the compressible portion. The compressible portion is comprised of a compressible material that preferably has a durometer hardness of between about 30 and 50 Shore A. In a preferred embodiment, the compressible portion includes a series of relatively enlarged diameter portions and a series of relatively reduced diameter portions. These relatively enlarged and relatively reduced diameter portions can take the form of a series of surface features selected from a group consisting of annular extending ribs, axially extending ribs, and helically extending ribs.

In another preferred embodiment, a valve stem extender is provided for use with a vehicle having a body having a tire receiving surface and a radially inwardly disposed surface that is spatially separated from the tire receiving surface. The tire receiving surface includes a first valve stem receiving aperture and a radially inwardly disposed surface includes a second valve stem receiving aperture having a diameter. A valve stem is provided having a proximal end disposed relatively nearer to the tire receiving surface and a distal end disposed relatively nearer to the radially inwardly disposed surface.

The valve stem extender includes a body portion having a proximal end portion, a distal end portion, an interior passageway and an exterior. The proximal end portion includes a first coupler for coupling to the second end of the valve stem. The distal end portion is configured for receiving an air introducing device. The exterior include a compressible portion. The compressible portion is compressible between a relaxed position having a diameter larger than the diameter of the second valve stem receiving aperture, and a compressed portion having a diameter of less than the diameter of the second valve stem receiving aperture.

One feature of the present invention is that it includes a compressible portion that is compressible between a relaxed position having a diameter greater than the diameter of a receiving aperture on a wheel, and a compressed portion having a diameter that is smaller than the diameter of the valve stem extender receiving aperture.

This feature has the advantage of providing a snug fit between the valve stem extender and the aperture of the wheel. By providing this snug fit, the valve stem extender does not rattle or move within the wheel or the aperture. Additionally, the valve stem extender helps to seal the opening of the aperture, to prevent the intrusion of water, dirt and other foreign matter, that can add weight to the wheel, impact the performance of the wheel, and possibly degrade the wheel.

These and other features and advantages of the invention will become apparent to those skilled in the art upon a review of the drawings and detailed description presented below.

### IV. BRIEF DESCRIPTION OF THE DRAWINGS

FIG. 1 is a perspective, partially sectional view of a prior art valve extender contained within a deep section rim;

FIG. 2 is a perspective, partially sectional view of a prior art valve extender contained within a deep section rim;

FIG. 3 is a sectional view of the valve extender of the present invention contained within a deep section rim;

FIG. 4a is a perspective view of a first embodiment valve stem extender of the present invention;

FIG. 4b is a perspective view of a second embodiment valve stem extender of the present invention;

FIG. 4c is a perspective view of a third embodiment valve stem extender of the present invention;

FIG. 5 is a perspective, partly sectional view of the valve stem of the present invention captured within a deep section rim; and

FIG. 6A is a sectional exploded view of a hollow tube embodiment of the valve stem extender of the present invention;

FIG. 6B is a sectional exploded view of a valve containing tube embodiment of the valve stem extender of the present invention.

FIG. 7 is a side view of the valve containing tube embodiment of the valve extender of the present invention; and

FIG. 8 is a side view of the valve stem assembly including the valve stem.

### V. DETAILED DESCRIPTION

The description that follows describes, illustrates and exemplifies one or more particular embodiments of the present invention in accordance with its principles. This description is not provided to limit the invention to the embodiment or embodiments described herein, but rather to explain and teach the principles of the invention in such a way to enable one of ordinary skill in the art to understand these principles and, with that understanding, be able to apply them to practice not only the embodiment or embodiments described herein, but also other embodiments that may come to mind in accordance with these principles.

The scope of the present invention is intended to cover all such embodiments that may fall within the scope of the appended claims, either literally or under the doctrine of equivalents. Unless otherwise noted, the term “fluid” should be read broadly enough to encompass both liquid and gaseous fluids, including air which will likely be the fluid of choice for most uses.

It should be noted that in the description and drawings, like or substantially similar elements may be labeled with the same reference numerals. However, sometimes these elements may be labeled with differing reference numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Furthermore, certain views are side views which depict only one side of the device (or one set of components of a multi set array of components), but it will be understood that the opposite side and other component sets are often preferably identical thereto. The present specification is intended to be taken as a whole and interpreted in accordance with the principles of the present invention as taught herein and understood by one of ordinary skill in the art.

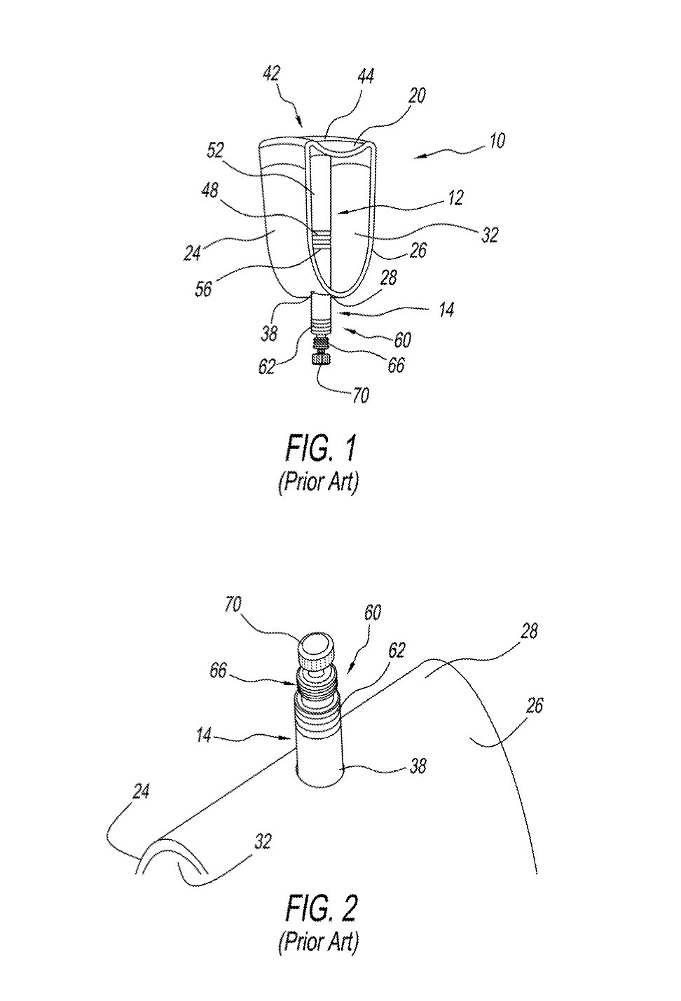

A prior art rim 10, valve stem 12 and valve stem extender 14 are shown in FIGS. 1 and 2. Generally, the prior art rim 10 and valve stem 12 will be used in connection with the inventive valve stem 100, 140 of the present invention. As discussed in more detail below, the valve stem extender 140, 100 of the present invention differs significantly and surprisingly from the valve stein extender 14 of the prior an.

The rim 10 is a bicycle wheel rim of a type that is commonly referred to as a “deep section” rim. The cut-away view of the rim 10 is a drawing of a rim that is similar to ZIPP SPEED WEAPONRY, 404 model rim, that is configured in a configuration commonly referred to as a “tubular”, “sew-up” or “non-clincher” configuration.

A tubular or non-clincher rim affixes the tire to the rim by glueing the tire and tube to the rim. Non-clincher rims differ from “clincher” rims, as clincher rims include an axially inwardly extending lip that engages a corresponding axially outwardly extending bead of the tire, so that the engagement of the lip and bead, when coupled with the inflation of the tire or tube, helps to securely attach the tire to the rim, thus obviating the need for any chemical connections, such as glue.

Examples of clincher rims can also be viewed at www.zipp.com, as the ZIPP 404 model rim comes in both the clincher and non-clincher version. Although clincher wheels are currently more popular, a strong market remains for tubular wheels. Because of the nature of the present invention, the valve extender of the present invention will work equally well with clincher and tubular wheels and rims.

The rim 10 can be made of any rigid material. Generally, lower priced rims are made of a metal material such as steel or aluminum, whereas more expensive wheels are often made from fiber plastic resin (carbon fiber) materials. Deep section rims such as those shown in FIGS. 1 and 2 are often made from carbon fiber through a molding process.

The rim 10 includes a radially outwardly facing, tire-engaging surface 20, against which a tire or tube is placed. The tire engaging surface 20 is perimetral, and extends around the outside diameter of the wheel. First and second side walls 24, 26 extend radially inwardly from the tire engaging surface 20, and meet together at a radially inwardly facing surface 28. Although these surfaces are described and numbered “separately”, it will be appreciated that they are usually formed as a unitary member having a hollow body 32.

An aperture 36 is formed in the radially outwardly facing tire engaging surface 20, that is positioned so as to be aligned with a corresponding aperture 38 that is formed in the radially inwardly facing surface 28. The apertures (not shown), 38 are designed to have a predetermined diameter and have an axis that is co-linear, so that a valve stem 12 and valve stem extender 14 that extend through the two apertures (not shown), 38 will be positioned to extend in a generally radially inward direction.

Typical current practice is to form at least valve hole 38 in the rim 10 to have a diameter between about 6.2 mm and 6.4 mm to accept a standard sized valve stem 12. The valve stem 12 includes a proximal or base end 42 that includes a relatively enlarged diameter base portion 44, that prevents the valve stem from moving radially inwardly through the aperture in the tire engaging surface 20. The valve stem 12 also includes a second or distal end 48 that includes a coupler, such as external male threads, and/or internal female threads.

In a conventional arrangement, the exterior male threads 48 are provided for enabling the distal end of the valve stem 12 to engage the interior female valve threads of a valve cap. The interior female threads of the valve stem 12 are designed primarily to engage the external male threads of an air flow control valve, such as a Presta valve or Schrader Valve, that are the two most common valves that are employed in connection with pneumatic tires and tubes.

The base 44 of the valve stem 12 is shown as being generally disk-like. The disk-like base 44 of the valve stem 12 suggests that the valve stem 12 shown in FIG. 1 is a valve stem that is designed for use with tubeless tires. On tube-type tires, the base 44 of the valve stem 12 would be affixed to the tube, so that the material of the tube would extend outwardly from the base 44, rather than the base 44 having a finite, coin-sized diameter.

A cylindrical central portion 52 extends between the proximal portion 42 of the base member and the distal portion 48. The central portion 52 includes a hollow interior passageway through which a fluid, such as air can pass. Additionally, an air flow control valve (not shown) such as the aforementioned Presta valve or Schrader Valve is disposed within the interior passageway of the central portion 52, to control the flow of air through the valve stem. In such cases, the valves are designed so as to normally be biased into the closed position, but to be movable into the open position when the valve stem is engaged with a valve depressing device or appropriate air pressure. To open a Schader valve, a mechanical force is required to push the valve axially into an open position by exerting a sufficient force against a spring that biases the valve into the closed position.

A Presta valve is normally biased into a closed position due to the pressure of the air on one side of the valve (e.g. inside the tube or tire) being greater than the air pressure on the other side of the valve (e.g. atmosphere). When an air delivery device such as an air pump creates a greater air pressure on the “atmosphere” side of the Presta valve, the pressure differential causes the Presta valve to open to thereby admit additional air into the interior of the tube or tire.

The valve extender 14 has a threaded proximal end 56 that is threadedly engaged to the distal end 48 of the valve stem 12, and a distal end 60. Distal end 60 includes a male threaded portion 62 for receiving female threads of the valve cap. Additionally, the vale stem extender 14 may include interiorly disposed female threads for receiving one of an air flow control valve.

A valve such as Presta valve 63 has male threads for threadedly engaging female threads at the distal end 60 of the valve stem extender 14. Alternately, the valve stem extender 14 can be designed to comprise little more than an open tube for receiving an air hose coupling, with the air flow control valve being coupled to the distal end of the valve stem 12.

The flow control valve 63 is shown in FIGS. 1 and 2 and includes a knurled knob 70 for manually closing and opening the Presta valve 63. The Presta valve 63 also includes a set of male threads 66 that are sized and configured for receiving the female threads of a valve cap. The threads 66 may include a “flat” for providing a wrench engaging surface so that the user can couple and remove the Presta valve 63 from the valve stem extender 14.

The aperture 38 in the radially inwardly facing surface 28 of the rim 10 typically has a diameter of between about 6.2 mm and 6.4 mm. This size is chosen so that the valve stem extender 14 can pass through the aperture 38, as the valve stem extender 14 is conventionally designed to have a diameter of between about 5.8 mm and 6.1 mm.

Due to this difference in diameter, a gap exists of typically between 0.3 mm and 0.6 mm between the extender 14 and the walls of the aperture 38. While not a great amount, this gap and diameter difference means that the valve stem extender 14 fits within a hole loosely enough so that it may move around and rattle during operation of the bicycle, and especially when the bicycle is being driven over rough pavement or roads. Additionally, as described in the Background, the gap created between the outwardly facing surface of the valve stem is great enough so as to allow water intrusion when the wheel is driven in the rain.

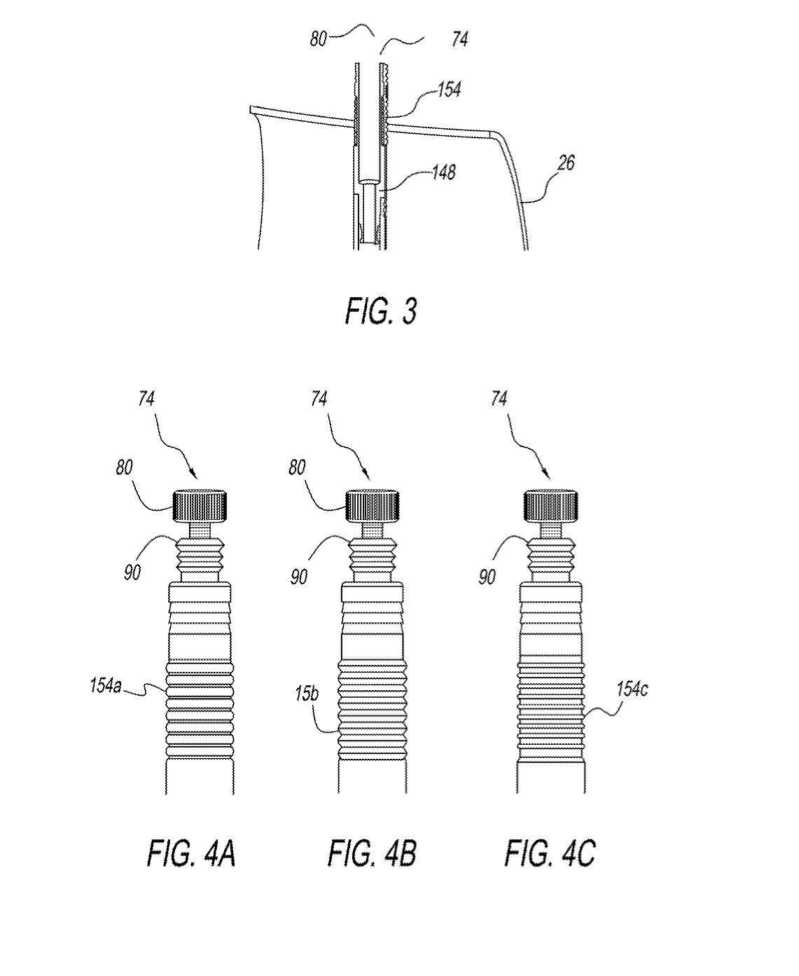

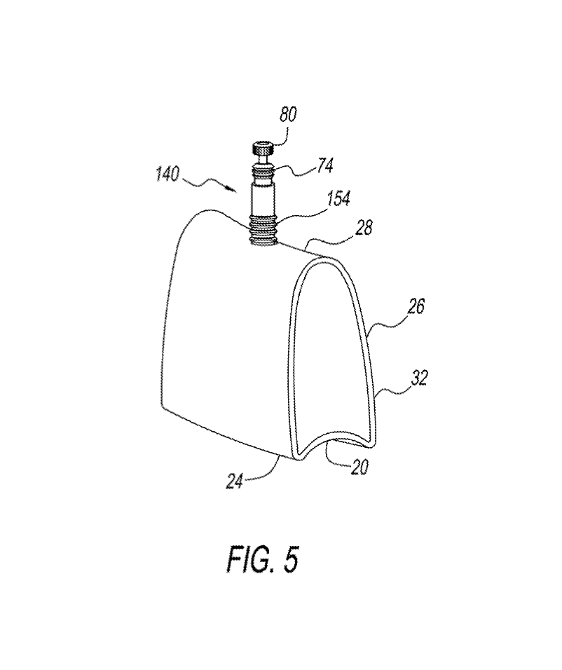

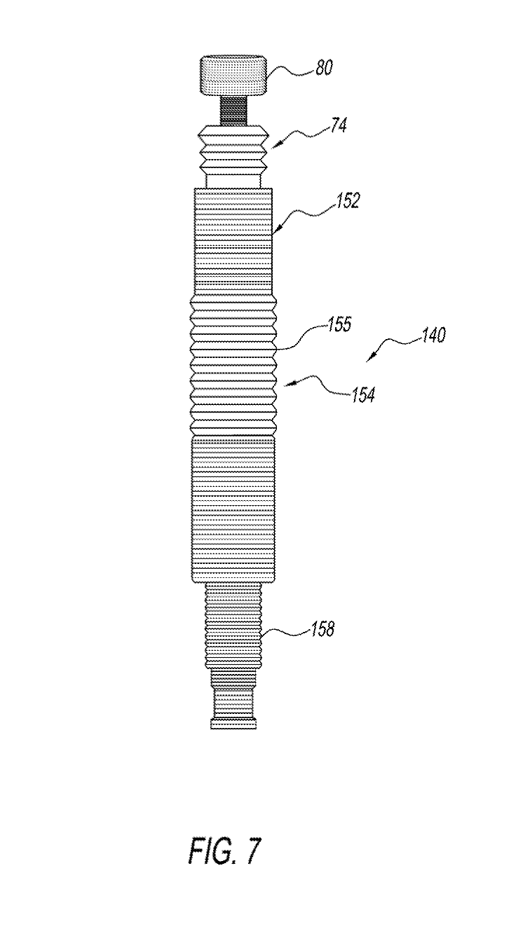

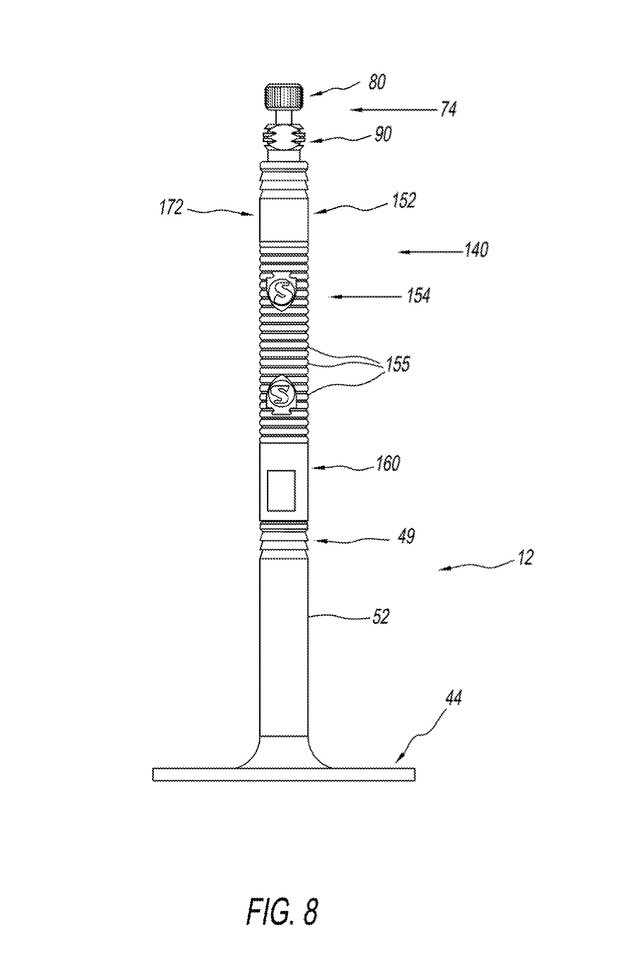

The valve stem of the present invention is best shown in FIGS. 3-7.

For purposes of simplicity, portions of the rim 10 and valve stem 12 shown in FIG. 3 et seq., will bear the same number, as they can be virtually identical to the rim 10 and valve stem 12 of the prior art shown in FIGS. 1 and 2. Different numbers will be used to describe the valve stem extender shown in FIG. 3 et seq., as the present invention comprises a significantly different device than the valve extender 14 shown in FIGS. 1 and 2.

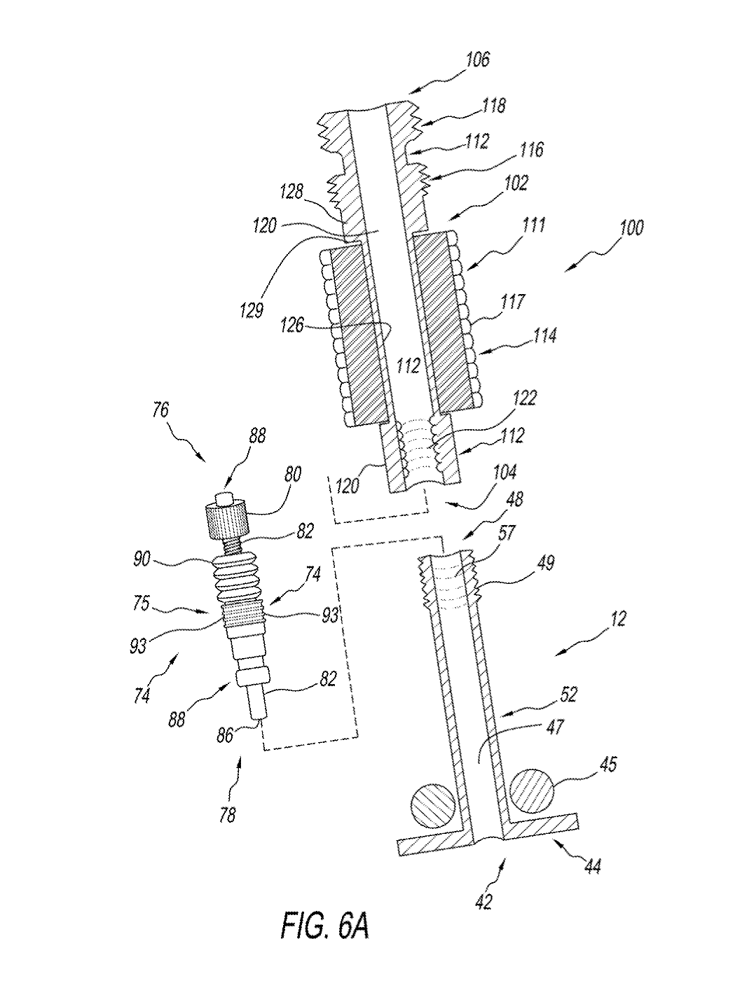

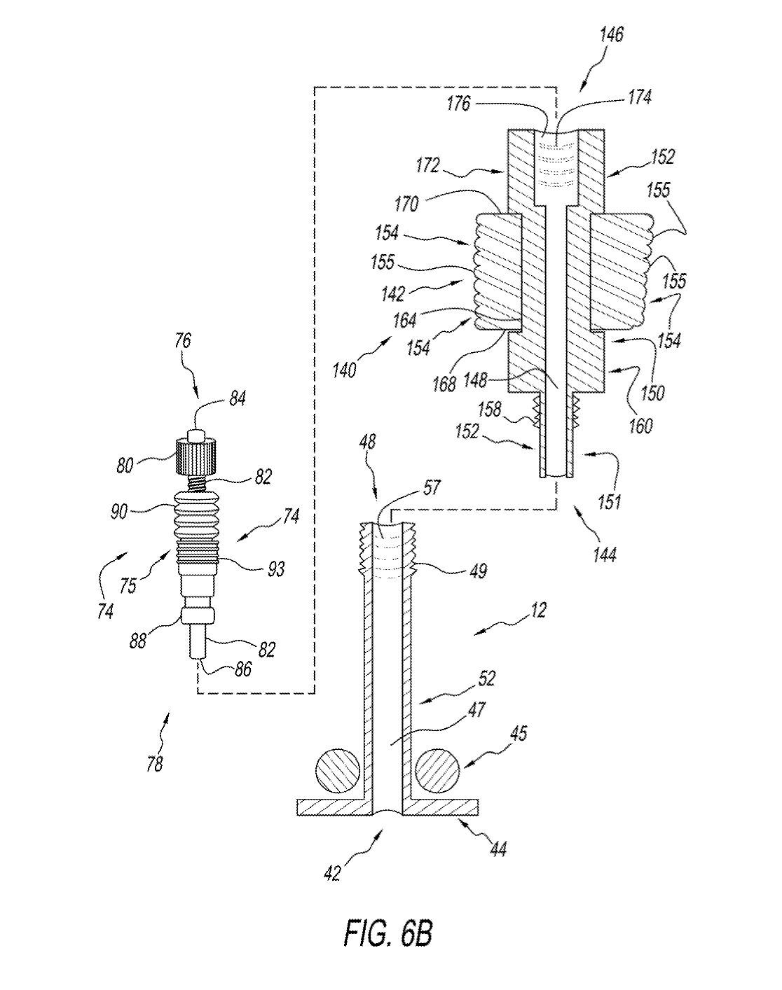

An exploded view of the valve stem extender 100 of the present invention is shown in FIG. 6A. Valve stem extender 100 comprises a first embodiment that is known as the “open tube” design type embodiment. The open tube design valve stem extender 100 essentially comprises a tube extender having an empty interior passageway. The flow control valve such as Presta valve 74, is inserted into the valve stem 12. The valve stem extender 100 couples to the valve stem 12, by threadedly engaging the Presta valve 74 that is coupled to the distal end 48 of the valve stem 12.

As alluded to above, the valve stem 12 is similar to the valve stem 12 shown in the prior art FIGS. 1 and 2. The particular valve stem 12 shown in FIG. 6A also includes a series of external threads 49 that are disposed adjacent to the distal end 48 of the valve stem 12, and a set of internal threads 57 that are sized and configured for receiving the interior male threads 93 of the Presta valve 74. An O-ring 45 is disposed adjacent to the base 48, for forming a tight seal at the place where the base 48 meets the aperture of the tire engaging surface of the wheel to which the valve stem 12 is attached. As with the valve stem 12 shown in FIGS. 1 and 2, the valve stem 12 of FIGS. 6A and 6B is generally shown as being a valve stem that is used with a tubeless-type tire.

A Presta valve 74 is inserted into the distal end 48 of the valve stem 12. Presta valve 74 may well be a standard, off-the-shelf Presta valve, and includes a plurality of components and parts. In particular, the Presta valve 74 includes a generally cylindrical body 75 having an exterior end 76 and an interior end 78. The “interior” end 78 is so named because it is the end of the Presta valve 74 that is typically placed adjacent to the high pressure volume such as the interior of the tire. The exterior end 76 is so named because it is typically placed in a relatively lower pressure area, such as atmosphere. The exterior end 76 is normally disposed exteriorly of the tire and wheel, so that one can attach air coupler adjacent to the exterior end 76 for inserting air into the tire to which the Presta valve 74 is contained.

The Presta valve 74 includes a locking knob 80 that is threaded coupled to a shaft 82, that extends throughout the length of the Presta valve 74. The locking knob 80 is provided for locking the shaft 82 and valve head 88 in a closed position when one wishes to ensure that the closing valve 84 of the Presta valve 74 is secured against its seat, to ensure that no air leaks out of the tire. The exterior end 84 of the shaft is disposed adjacent to the locking knob 80 and the distal end 86 is disposed adjacent to the closeable valve and O-ring 88.

The body of the Presta valve 74 includes an exteriorly disposed set of male threads 90, that are sized and configured for receiving either (1) a screw-on type air dispensing coupler; (2) interiorly disposed female threads of the proximal end of the valve stem extender; or (3) a valve cap (not shown). Additionally, the Presta valve 74 includes a set of male exterior threads 93 that are disposed relatively interiorly, when compared to exterior male threads 90. The interior set of male threads 93 are sized and configured for being threadedly received by the female threads 57 that are disposed near the distal end of the valve stem 12, for threadedly coupling the Presta valve 74 to the valve stem 12. As will be discussed in more detail below, the threads 93 can also engage similar threads that are positioned similarly to threads 57 on the valve stem extender in the “valve containing” variant of the present invention.

Valve stem extender 100 shown in FIG. 6A is a tube-type, non-valve containing valve extender embodiment 100. The valve stem extender 100 includes a generally cylindrical tube-like body 102 having a first or proximal end 104, that is disposed adjacent to the valve stem 12, and a distal end 106. The distal end 106 is usually disposed exteriorly of the wheel and is the end to which an air introducing device such as an air pump coupler is coupled for introducing air through the valve stem extender 100, through the valve stem 12, and ultimately into the tire tube that is being inflated.

The valve stem extender 100 includes a hollow passageway 110 that extends between the proximal 104 and distal 106 ends of the valve stem extender 100, and through which air can pass. The body 102 also includes an exterior 111, that includes various surface features, such as an enlarged diameter portion 120. A reduced diameter portion 126, ribs 116 and threads 118 that perform various functions, as will be discussed below in more detail. The rigid portion 112 is generally made of a relatively rigid material, such as metal or plastic. Although plastic can be used, metal is generally preferred because it is easier to create durable, fine threads using a machined metal, than a molded plastic. As most plastics are softer than metals, the use of plastic to form rigid threads tends to produce a device that is not as durable as one that is comprised of a metal member. However, it will also be appreciated that various multi-material parts, such as a carbon fiber having metal sleeves, etc., may also be employed for the rigid portion 112.

In addition to the rigid portion 112, a compressible portion 114 is provided. The compressible portion 114 is made from a compressible material, and is radially compressible between a relaxed position wherein the diameter of the compressible portion 114 is generally greater than the aperture of the wheel through which the valve stem extender 100 extends; and a compressed position wherein the compressible portion 114 has a diameter that is less than the aperture of the wheel into which the valve stem extender 100 is inserted. This compressibility enables the user to insert the valve stem extender 100 through the aperture of the tire, preferably, with little more than hand pressure, so that the compressible portion 114 will compress when going through the aperture, and then when seated in place, will expand against the aperture to form a tight and waterproof seal against the aperture. Additionally, the tightness and snugness of the engagement between the compressible portion 114 and the aperture 38 of the wheel is such that the valve stem extender 100 is generally fixed in place, and cannot “rattle around” within the aperture.

The compressible portion 144 preferably comprises a sleeve that is molded to have a tubular configuration. The inner diameter of the tube should be sized to snugly receive the exterior surface of the reduced diameter portion 126 of the rigid portion 112 of the valve stem extender 100. The exterior surface should preferably have surface features that aid in the gripping of the compressible portion 114 to the rim of the aperture 38 of the wheel through which the valve stem extender 100 extends. These surface features can take a variety of shapes. For example, the surface features can take the shape of a series of annular rings, as shown in FIG. 6A. Alternately, the surface features can comprise a series of axially extending rings, or helical rings. Additionally, random surface features, such as blocks, and the like may be employed.

In certain embodiments, it may be useful to create surface features, such as annular rings 117 that create an exterior of the compressible member 114 having relatively enlarged diameter portions and relatively reduced diameter portions. In one embodiment, the relatively enlarged diameter portions can have a relaxed diameter that is greater than the normal diameter of the aperture, whereas the relatively reduced diameter portions of the cylindrical compressible portion 114 can have a diameter when in the relaxed position of something less than the diameter of the aperture 38. This sort of configuration would also work well with the helical surface features, as such a configuration would enable the compressible portion 114 and valve stem extender 100 to be “screwed” into the aperture 38, so as to foster axial movement of the valve stem extender 100 in the aperture 38.

The rigid portion 112 includes a proximal portion 120 that includes a series of female internal threads 122. The female internal threads 122 are sized and configured for engaging the exteriorly disposed threads 90 of the Presta valve 74.

A reduced diameter compression member receiving portion 126 is disposed exteriorly of the proximal portion 120, and includes an interior diameter that is generally equal to the interior diameter of the remaining portion of the hollow passageway 110, but an exterior diameter that is generally less than for example, the enlarged diameter proximal portion 120. The reduced diameter is used in the reduced diameter portion 126 so as to provide shoulders at each end of the reduced diameter portion for properly seating and preventing the axial movement of the compression portion 114 sleeve in an axial direction along the valve stem extender 100.

A relatively enlarged diameter portion 128 is disposed just exteriorly of the reduced diameter portion 126. The intersection of the reduced diameter portion 126 and enlarged diameter portion 128 on the exterior of the rigid portion 112 creates a shoulder 129 that as described above, helps to maintain the axial position of the compression member sleeve 114 on the valve stem extender 100.

A ribbed portion 116 is disposed exteriorly of the enlarged diameter portion 128, and a distal portion 118 having male threads is disposed at the generally distal end 106 of the valve stem extender 100.

The compression member 114 is preferably made from a compressible material such as a rubber or soft plastic material. It has been found by the Applicant that a compressible material, such as thermal plastic polyurethane (TPU), Ethylene, Propylene Diene Monomers (EPDM), Buna-N (a synthetic rubber) or natural rubber, works well in connection with the present invention. Although these materials work well, other similar elastic materials that can be designed with appropriate strength and compressibility features will likely also work.

Although the compression member 114 is shown as being designed to be a sleeve, it will also be appreciated that the compression member 114 may be added to the rigid member 112 through a “molding”, co-molding, over molding, or co-bonding techniques.

Of the materials discussed above, appropriately formulated thermo plastic polyurethane (TPU) materials have been found by the Applicant to serve well, due to their good solvent, chemical and weather resistance. TPUs can be formulated down to very low durometers, so that TPU materials can be made to be very soft and pliable, while still having good tear and abrasion resistance. From tests being conducted to date, it is believed that the optimal durometer hardness of a compression portion 114 of the present invention is between about 0 and 80 Shore A, a more preferred embodiment being between about 30 and 50 Shore A, and the most preferred embodiment being about 40 Shore A.

The scaling exterior surface of the compression member 114 can take on any geometry that is capable for allowing radial displacement within the desired gap and stem hole.

In addition to the shape discussed above, semi-circular ribs, thin rectangular sectioned ribs, quarter ribs and others, will also work well in the present invention.

A variety of other annular protrusions may work well, such as the helical spirals discussed above, along with various geometric shapes, such as triangles, rectangles, squares, parallelograms, trapezoids, ellipses, and any portion of a circle ellipse or circular shape and possibly other shapes. One value of the feature of using geometric shapes that have a relatively enlarged diameter portions and relatively reduced diameter portions is that the use of such shapes facilitate the passage of the compressible portion 114 through the aperture as the bending permitted by spaces between adjacent enlarged diameter portions helps to make pushing the compression portion of the valve stem 12 through the aperture 38 of the wheel easier, as the bending fosters a lower amount of resistance to such movement.

The second embodiment valve stem extender 140 is shown in FIG. 6B. Valve stem extender 140 is a valve containing valve stem extender 140. Whereas the valve stem extender 100 shown in FIG. 6A is generally a hollow tube that relies on a Presta valve 74 that is inserted into the valve stem 12, valve stem extender 140 uses the valve stem 12 as a hollow tube, as the Presta valve 74 is inserted into the distal end 146 of the valve stem extender 140.

Although valve stem extender 140 is shown as being sized and configured for the insertion of a Presta valve 74, it will also be appreciated that valve stem extender 140 is well suited for use with the Schrader valve. Unlike Presta valve 74 that can be actuated by air pressure, the Schrader valve (not shown) requires a mechanical actuation to move the valve member against the action of the spring into its open position.

Since the valve stem extender 140 places the valve in a position adjacent to the distal end 146 of the valve stem extender 140, an air introduction coupling, such as an air hose coupling that includes a mechanical finger for actuating the Schrader valve could be positioned to actuate a Schrader valve that was placed in the distal end 146 of the valve stem extender 140. In contrast, a Schrader valve that was placed in the distal end 49 of a valve stem 12 would likely have its actuating finger too far removed from the distal end of the combined valve stem extender 100 to enable the air hose coupling to exert a mechanical pushing force against the Schrader valve finger, unless some sort of extender finger member was employed within the valve stem extender 100.

The valve stem extender 140 includes a body 142 having a first or proximal end 144 that is sized and configured for being received by the distal end 48 of the valve stem 12. The body 142 also includes a second or distal end 146 that is sized and configured for interiorly receiving the interior end 78 of the Presta valve 74, in a manner such that a portion of the Presta valve 74 such as knurled knob 80 and the exterior end 76 of shaft 84 protrude exteriorly out of the distal (2^{nd}) end 146 of the valve stem extender 140.

The body 142 also includes a hollow, axially extending interior passageway 148, and an exterior 150 that includes a plurality of different portions having different diameters and different configurations. The body 142 includes a rigid portion 152 that is preferably made from a metal, and a compressible portion 154 that is preferably made from an elastic or elastomeric material of a kind similar or identical to elastic and elastomeric materials discussed above in connection with the valve extender 100 of FIG. 6A. The compressible portion 154 is designed to be generally similar in size, shape and configuration to the compressible portion 114 of FIG. 6A, and includes a plurality of surface features 155, that may be similar to surface features discussed in connection with valve stem extender 100 of FIG. 6A.

Returning now to the rigid portion 152, a reduced diameter proximal portion 156 is disposed adjacent to the proximal end 154 of the rigid portion 152. The proximal portion 156 includes a male threaded portion 158 that is sized and configured for being received by the female interior threads 57 that are disposed on the wall of a hollow passageway 47 of the valve stem 12.

An enlarger diameter flat containing portion 160 is disposed generally distally of the proximal portion 156. The enlarged diameter flat-containing portion can be generally cylindrical in configuration, with a pair of opposed flats that are sized and positioned to be received by a gripping tool such as a wrench or pliers to enable the user to exert a leveraged force when threadedly engaging the valve stem extender 140 into the valve stem 12.

A reduced diameter seat portion 164 is disposed generally distally of the enlarged diameter flat containing portion 160. The reduced diameter seat portion 164 serves as a seat for the compressible portion 154. The seat portion 164 is defined as the area between a first or proximal shoulder 168 and the second or distal shoulder 170. The first or proximal shoulder 168 is formed at the intersection of the enlarged diameter flat containing portion 160 and reduced diameter seat portion 164. The second or distal shoulder 170 is formed at the intersection of the reduced diameter seat portion 164 and the enlarged diameter distal portion 172. The enlarged diameter portion 172 has a diameter that is large enough to accommodate a hollow interior passageway portion that has a diameter large enough to enable the female threads 174 that are formed on an interior surface 176 to receive the male threads 93 of the Presta valve 74.

The operation of the compressible portion 154 of valve stem extender 140 is generally similar to the operation of the compressible portion 111 of valve stem extender 100 shown in FIG. 6A.

In order to operate the present invention, a valve stem 12 is employed. If the valve stem 12 is part of a tube, the tube of a tube-type tire is placed adjacent to the tire engaging surface of the rim or wheel, such that the valve stem 12 is positioned to extend through a first aperture that is formed in the tire engaging surface of the rim. However, prior to the insertion of the valve stem 12 through the aperture, the valve stem extender (100 or 140) and Presta valve 74 are joined to the valve stem 12.

In the device of FIG. 6A, the components are joined by first inserting the Presta valve 74 into the distal end 48 of the stem 12, by engaging threads 93 with threads 57. The proximal threads 122 of the valve stem extender 100 are then coupled to the exterior threads 90 of the Presta valve 74. Prior to making this connection, it is advisable to turn the locking nut 80 of the Presta valve 74 into an unlocked position, as when assembled, it will be difficult to access the turning knob 80.

The assembled Presta valve 74, valve extender 100 and valve stem 112 are then inserted radially inwardly through the aperture on the tire receiving surface, and extended so that the valve extender 100 extends through the second aperture 38 that is formed in the radially interiorly facing surface of the deep dish wheel. Preferably, the axial position of the valve extender is such so that the compressible portion 114 engages the surface of the aperture.

As the valve stem extender 100 is pushed through the second aperture 38, the compressible member will move between from its relaxed position (that is greater than the diameter of the aperture 38), into its compressed position that is smaller than the diameter of aperture 38, so that the compressive member 111 and hence the valve stem extender 100 can be pushed through the aperture. When so engaged, the compressive member 111 will tend to relax to snugly engage the radially inwardly facing surface of the aperture 38.

The same procedure is generally followed with a tube type tire, except that the valve stem 12 and Presta vale 74 and extender 100 assembly are inserted through the respective aperture prior to the tire being inserted.

The same general procedure is followed with respect to the extender 140 assembly shown in FIG. 6B. However, the assembly of FIG. 6B is assembled by threadedly engaging the threads 158 of the proximal portion of the valve extender 140 into the female threads 57 that are disposed at the interior of the distal portion 48 of the valve stem 12. Once the valve stem extender 140 and valve stem 12 are joined, the Presta valve 74 is then joined to the distal portion 146 of the valve stem extender by engaging the threads 93 of the Presta valve with the interior female threads 174 that are disposed at the distal end portion 146 of the valve extender 140.

Again, as the valve extender 140 is being pushed through the second aperture, the compressive portion 142 will move between its relaxed position wherein it has a diameter greater than the diameter of the aperture 38 to a compressed position, wherein the diameter 140 of the compressive portion 142 is less than the diameter of the aperture so it can pass there through.

What is claimed:

1. A valve stem extender configured for being coupled to a valve stem having a fluid receiving passageway for use with a vehicle wheel and tire, the valve stem extender comprises
a body having a proximal end portion, a distal end portion, an interior passageway extending between the distal and proximal end portions, and an exterior the proximal end portion including a coupler for coupling the valve stem extender to a valve stem to place the interior passageway of the valve stem in fluid communication with the fluid receiving passageway of the valve stem extender, the distal end portion being configured for receiving an air introducing device, and wherein the body includes a compressible portion, the compressible portion being radially compressible between a relatively larger diameter relaxed position and a relatively smaller diameter compressed position.

2. The valve stem extender of claim 1 wherein the body includes a relatively rigid portion disposed interiorly of the compressible portion, the compressible portion comprised of a compressible material.

3. The valve stem extender of claim 1 wherein the compressible material comprises a compound including a material selected from the group consisting of thermoplastic polyurethane (TPU), Ethylene propylene diene monomer (EPDM), synthetic rubber, and rubber.

4. The valve stem extender of claim 3 wherein the compressible material has a durometer hardness of between about 1 and 80 Shore A.

5. The valve stem extender of claim 3 wherein the compressible material has a durometer hardness of between about 30 and 50 Shore A.

6. The valve stem extender of claim 1 wherein the compressible material has a durometer hardness of between about 30 and 50 Shore A.

7. The valve stem extender of claim 1 wherein the body includes a relatively interiorly disposed rigid portion and the compressible portion is disposed relatively exteriorly of the rigid portion.

8. The valve stem extender of claim 7 wherein the rigid portion is comprised of at least one of a fiber resin plastic and metal material.

9. The valve stem extender of claim 7 wherein the compressible portion comprises a selectively removable sleeve of compressible material.

10. The valve stem extender of claim 7 wherein the compressible portion comprises a coating of a compressible material having a durometer harness of between about 30 and 50 Shore A.

11. The valve stem extender of claim 10 wherein the compressible portion includes a series of relatively enlarged diameter portions and a series of relatively reduced diameter portions.

12. The vale stem extender of claim 11 wherein the series of enlarged diameter portions comprise surface features selected from the group consisting of annular extending ribs, axially extending ribs, and helically extending ribs.

13. The valve stem extender of claim 10 wherein the vehicle wheel includes an aperture having a diameter, the aperture being positioned for receiving the valve stem extender, wherein the enlarged diameter portion has a diameter greater than the diameter of the wheel aperture.

14. The valve stem extender of claim 1 wherein the vehicle wheel includes an aperture having a diameter, the aperture being positioned for receiving the valve stem extender, wherein the compressible portion is positioned to be received in the aperture, and wherein the compressible portion includes portions having a diameter greater than the aperture when in the relaxed position, and a diameter smaller than the aperture when in the compressed position.

15. The valve stem extender of claim 1 wherein the valve stem includes a valve member coupled to the valve stem, and the coupler for coupling the valve stem extender to a valve stem is configured for coupling the valve stem extender to the valve member.

16. The valve stem extender of claim 1 wherein the valve stem extender includes a valve member coupled to the distal end portion of the valve stem extender and positioned for being actuated by an air introducing device.

17. A valve stem extender for use with a vehicle wheel having a body having a tire receiving surface and radially inwardly disposed surface spatially separated from the tire receiving surface, the tire receiving surface including a first valve stem receiving aperture and the radially inwardly disposed surface including a second valve stem receiving aperture having a diameter and a valve stem having a proximal end disposed relatively nearer to the tire receiving surface and a distal end disposed relatively nearer to the radially inwardly disposed surface,
the valve stem extender including a body having a proximal end portion, a distal end portion, an interior passageway and an exterior, the proximal end portion including a first coupler for coupling to the second end of the valve stem, the distal end portion being configured for receiving an air introducing device and the exterior including a compressible portion, the compressible portion being compressible between a relaxed position having a diameter larger than the diameter of the second valve stem receiving aperture, and a compressed position having a diameter less than the diameter of the second valve stem receiving aperture.

18. The valve stem extender of claim 17 wherein the body includes a rigid portion disposed interiorly of the compressible portion, and the compressible portion is comprised of a compressible material.

19. The valve stem extender of claim 17 wherein the compressible material has a durometer hardness of between about 30 and 50 Shore A and wherein the body includes a relatively interiorly disposed rigid portion and the compressible portion is disposed relatively exteriorly of the rigid portion.

20. The valve stem extender of claim 17 where in the distal end of the valve stem extender includes a valve receiving portion for receiving a valve member, and the rigid portion includes a reduced diameter compressible member receiving portion for receiving the compressible portion.

21. The valve stem extender of claim 17 wherein the compressible portion comprises a sleeve of a compressible material having a hollow central passageway for receiving the reduced diameter compressible member receiving portion of the rigid portion.
